(19) United States
(12) Patent Application Publication
(10) Pub. No.: US 2016/0235625 A1
(43) Pub. Date: Aug. 18, 2016

(54) Back AcuBalls

(71) Applicant: Walton Lee, El Cerrito, CA (US)

(72) Inventor: Walton Lee, El Cerrito, CA (US)

(21) Appl. No.: 14/625,369

(22) Filed: Feb. 18, 2015

(51) Int. Cl. A61H 39/04; A61H 15/00

(52) U.S. Cl. CPC A61H 39/04; A61H 15/00; A61H 2201/1284; A61H 2203/0456; A61H 2205/081

(57) ABSTRACT

Some Chinese people rotate two ping-pong-sized iron balls on their palm to help blood circulation in order to upkeep their health. Instead of exercise on palms, you can exercise on your back. Instead of zero pressure point located on palms, you are taking care of 112 hard-to-reach and least-learned pressure points. With two rubber balls between your back and a hard floor, you are probing, scrutinizing and rubbing away ill health.

Western medicine is to cure diseases. Eastern medical philosophy is to build up strength and prevent illness. If we routinely listen to our body, detect and resolve its “complaints” in their incipient stage, we should be able to avoid medical complication down the road. Following the theory of Chinese acupuncture, I invented Backacu Balls from the ancient tradition to deal with health in general and urinary issues in particular.

### CROSS-REFERENCE TO RELATED APPLICATIONS

This application claims the benefit of U.S. Provisional Applications No. 62/110,969 and 62/116,421, filed Feb. 2, 2015 and Feb. 14, 2015, the disclosures of which is incorporated herein by reference.

### BACKGROUND OF THE INVENTION

This invention relates in general to Chinese acupuncture and a method for manipulating bodyweight toward 112 pressure points located on the back of a human body.

Chinese acupuncture is enigmatic to the general public. There are 361 named pressure or reflective points, catogorized into 12 primary meridians and two major extraordinary vessels; They are Heart Meridian (HT1-9), Pericardium Meridian (PC1-9), Lung Meridian (LU1-11), Spleen Meridian (SP1-21), Liver Meridian (LR1-14), Kidney Meridian (KI1-27), Small Interstine Meridian (SI1-19), Triple Energizer Meridian (TE1-23), Large Intestine Meridian (LI1-20), Stomach Meridian (ST1-45), Gallbladder Meridian (GB1-44), Urinary Bladder Meridian (BL1-67), Conception Vessel (CV1-24) and Governing Vessel (GV1-28).

The interpretations on those pressure points are imprecise and even contradictory. BL34, for instance, has an indication of stomachache, from one source. From another one, it has indications of pelvic inflammatory, hypertension, and prostate infection. For another example, BL35 has an indication of blood in feces. Other sources provide indications of urinary incontinence, retention, erectile dysfunction and prostate infection. The salient difficulty of acupuncture is that it is not yet scientifically studied and couldn't pin point a specific group of the pressure points in relationship to a certain illness. Due to the multitude of its numbers, complexity of its practice and inconsistency of its interpretations, it is impossible, impractical and tedious for any layman to comprehend them.

According to Chinese medical philisophy, those 361 pressure or reflective points are “sensors” on human topography. A grumpy organ registers its complaints on some of them, which are often far away from the grumbler. While touched those “registered” pressure points, you could feel the reflective numb, pain, sore, node or lump. Needle is the best way to stimulate them. Finger has some effect. Placing two rubber balls with one's bodyweight against one's back should also work.

Consistantly pressing and rubbing those “registered” points, you can alleviate, improve and even heal that irate organ in days or weeks.

Our back has 112 pressure points; 14 of them belong to Governing Vessel (GV1-14), 80 of them belong to Urinary Bladder Meridian (BL11-36, 41-54), 14 of them belong to Small Interstine Meridian (S19-15), and four belong to Triple Energizer Meridian (TE14-15). Due to its hard-to-reach location and proxemity between one point to another, it is handled by arcupunctuists only. From one source, www.all-about-acupuncture.com/urinary-bladder-acupuncture-points.html, I surprisingly found some (BL27-58) of their indications are blank. I conjecture those points' indications are the least known.

Fortunately, those pressure points are all lined up on the least travelled human “highways.” They are spreading almost all on the five routes; Two (BL11-30) of them are located 1.5 inches apart from and the other two (BL41-54) are located 3 inches apart from the backbone, the famous Governing Vessel (GV1-14). Under the five human “highways,” eighty pressure points belong to Urinary Bladder Meridian. If you have urinary issues, which should be interpreted in the broadest sense, your organs would definitely register their complaints there.

Learning all the challenges, I devised a task-oriented approach. Instead of learning the indications of those numerous and cryptic points, I merely focus on the “complaints.” If you have C ailment, for example, you won't care about A, B, or D illness. Same attitude could be applied here. Just track down the “registered” reflective points, whether they are from organ A or organ B is immaterial. Round up all the “usual suspects,” pick out and rub off the “complaints.” With your endurance and persistence, you can rejuvenate your health.

### SUMMARY OF THE INVENTION

By stimulating and restoring “registered” reflective points on a human's back, this therapeutic device is a do-it-yourself back acupuncture instrument for rejuvenating strength in general and improving urinary issues in particular. It is in the form of two small rubber balls (tennis ball size) attached by a cord of seven inches in total length, by a cord-end to adjust and lock in the length of four inches. Each ball is placed on the back of a user's paired “registered” pressure point and manipulated by the user's bodyweight.

### DESCRIPTION OF THE DRAWINGS

FIG. 1 is the drawing of a human's back with 112 pressure points on five routes.

FIG. 2 is the drawing of the theory of invention.

FIG. 3 is the device in four inches.

FIG. 4 is the device in seven inches.

FIG. 5 is the drawing of the device and a human's back.

FIG. 6 is the model in action.

### DETAILED DESCRIPTION OF THE INVENTION

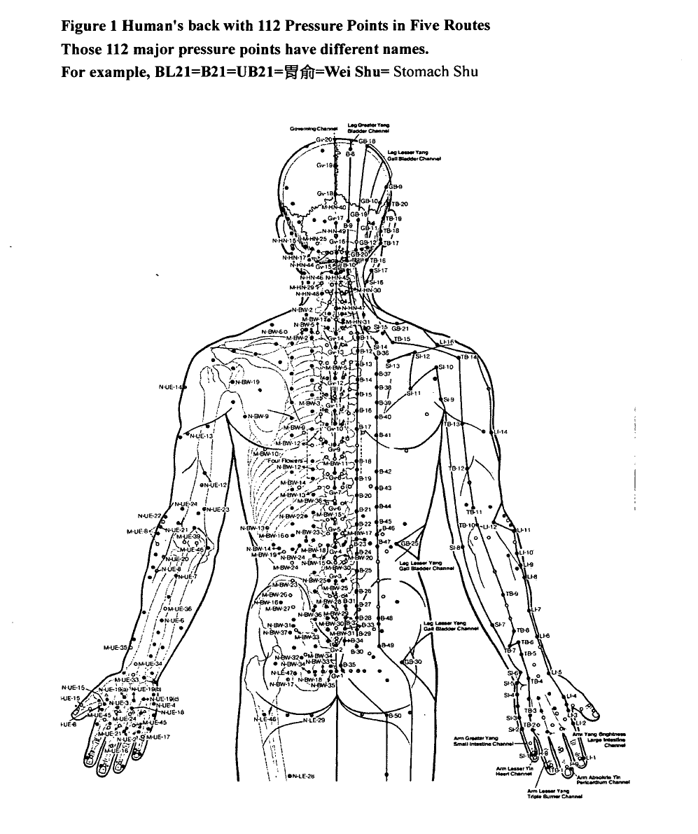

Now as reference to FIG. 1, there are five human “highways” lined up on the back of a human's topography; the inner two are 1.5 inches and the other two are 3 inches away from the backbone.

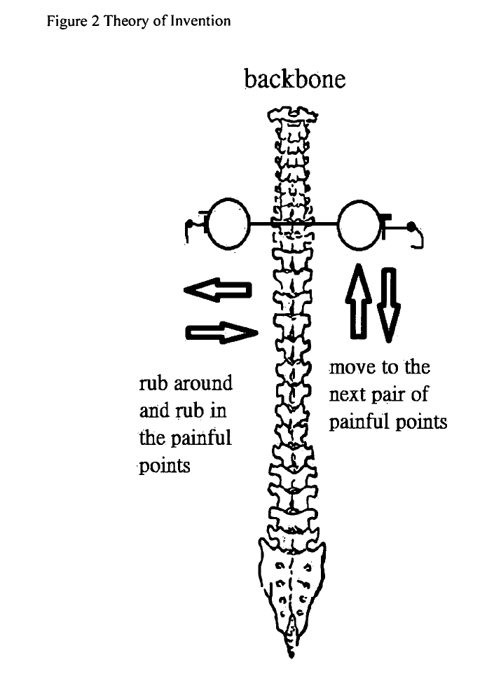

As reference to FIG. 2, my invention is utilized as a service vehicle on those human “highways.” With fingers, you can minutely nudge it along those two routes.

With the movements of your legs, hip and waist, you can probe, exame, press, rub in and eventually rub away the ill health.

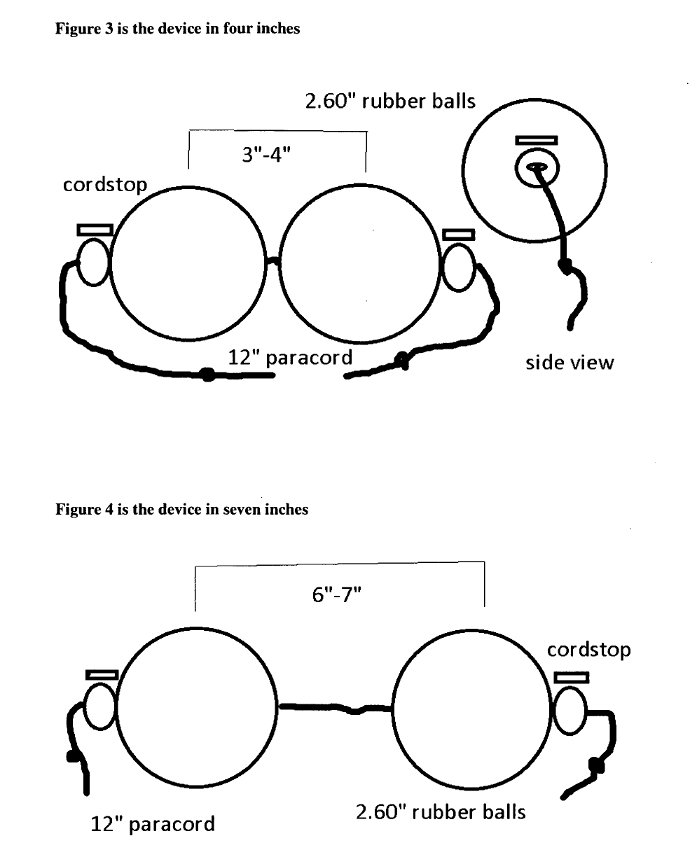

As reference to FIG. 3 and FIG. 4, there are two views of the device, which is created by attaching two tennis-ball-size rubber balls with one paracord and with one cordstop on the end for adjustment of length; any length is feasible as long as it can touch the “registered” spots.

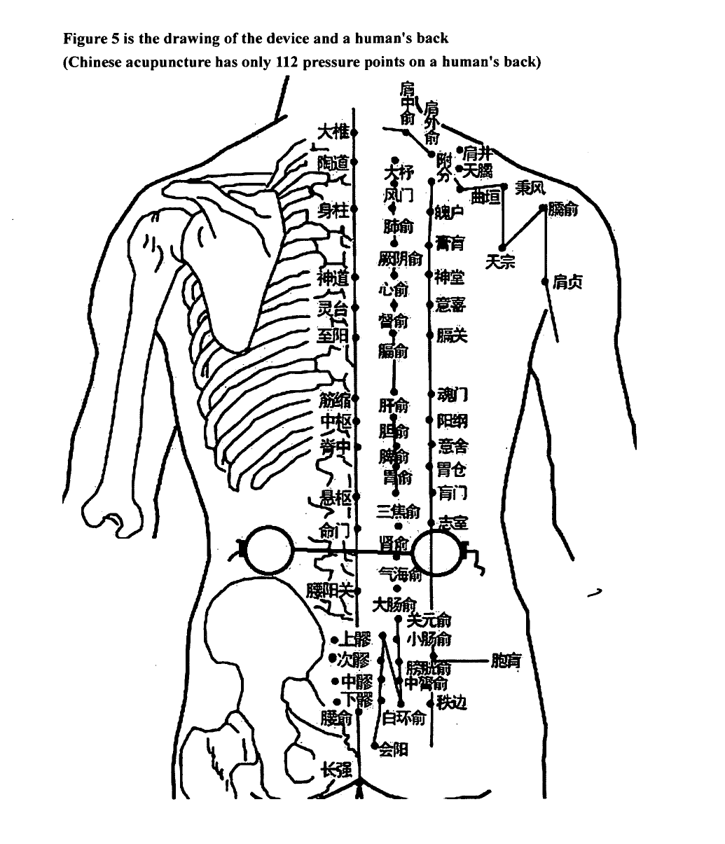

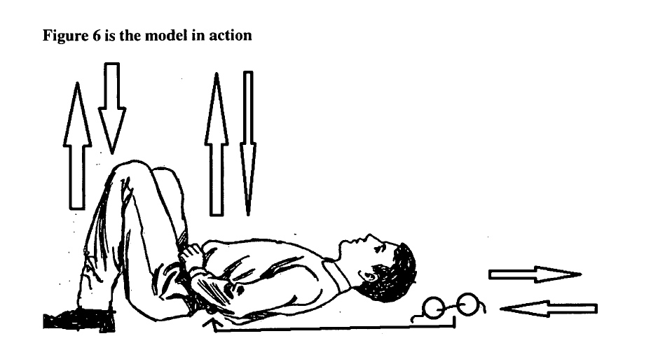

As reference to FIG. 5, this is how to use this device on human's back. Plowing forward or backward, the user could scrutinize the sensors' conditions along those “highways.”

As reference to FIG. 6, the user lie on floor and face up. Placing this device between the solid surface and the user, he can manipulate his bodyweight with two bended legs, hip, and waist, against it. He uses his fingers to nudge the balls, one at a time, forward, gradually pressing, rubbing around and rubbing in those “registered” pressure points. By repeating those movements for two to three minutes per point, he is stimulating, repairing and refreshing his strength.

This is a very low-cost, safe, effective, and self-healing device. Furthermore, it is non-invasive, easy to use over and superior than other alternative treatments.

By combining reflexology (finger) and acupuncture (needle) with bodyweight, I invented a new tool from two old concepts. This invention, a DIY back acupunctural device, is much powerful than finger and more affordable than acupuncture.

I claim:

1. An apparatus was created from two old concepts: reflexology (finger) and acupuncture (needle). Manipulating one's bodyweight against this apparatus placed between the “registered” pressure points on one's back and a floor could rejuvenate the functionality of one's “grumbling” organs.

2. This apparatus is safe and non-invasive.

3. It is an do-it-yourself, and self-healing “exercise.”

4. This apparatus is much powerful than fingers and more affordable than acupuncture.

5. You can do it at your leisure time 24/7.
